(19) United States
(12) Patent Application Publication
(10) Pub. No.: US 2021/0367284 A1
(43) Pub. Date: Nov. 25, 2021

(54) RECHARGEABLE BATTERY PACK

(71) Applicant: Robert Bosch GmbH, Stuttgart (DE)

(72) Inventors: Josef Baumgartner, Wildberg (DE); Andrej Stepanov, Filderstadt (DE); Florian Kneer, Duernau (DE)

(21) Appl. No.: 17/323,344

(22) Filed: May 18, 2021

(30) Foreign Application Priority Data
May 25, 2020 (DE) 102020206446.6

(51) Int. Cl. H01M 10/48; H01M 10/42; H01M 10/44; H01M 50/247; H01M 50/262; H01M 50/204

(52) U.S. Cl. CPC H01M 10/486; H01M 10/425; H01M 10/441; H01M 2220/30; H01M 50/262; H01M 50/204; H01M 50/247

(57) ABSTRACT

A temperature sensor device for a battery pack. The temperature sensor device has an electronics unit including a circuit board, at least one temperature sensor which is connected to the electronics unit, the temperature sensor being connected to the electronics unit with the aid of a carrier element, the carrier element being fastened at a first fastening point and at a second fastening point on the circuit board, and the at least one temperature sensor is situated in the region of the second fastening point. A positioning element is placed between the circuit board and the carrier element in the region of the second fastening point, which is developed for positioning the at least one temperature sensor.

### CROSS REFERENCE

The present application claims the benefit under 35 U.S.C. § 119 of German Patent Application No. DE 102020206446.6 filed on May 25, 2020, which is expressly incorporated herein by reference in its entirety.

### BACKGROUND INFORMATION

European Patent Application No. EP 3 364 493 A1 describes a battery pack which has a circuit board fitted with a temperature sensor.

### SUMMARY

The present invention relates to a temperature sensor device for a battery pack, which has an electronics unit including a circuit board, at least one temperature sensor connected to the electronics unit, the temperature sensor being connected to the electronics unit with the aid of a carrier element, the carrier element being at a first fastening point and at a second fastening point on the circuit board, and the at least one temperature sensor is situated in the region of the second fastening point. In accordance with an example embodiment of the present invention, it is provided to place a positioning element, which is developed to position the at least one temperature sensor, between the circuit board and the carrier element in the region of the second fastening point. This advantageously ensures an optimal positioning of the temperature sensor.

In particular, the first fastening point and the second fastening point are placed at a distance from each other such that the positioning element is spaced apart from the first fastening point. The temperature sensor is preferably situated closer to the second fastening point than to the first fastening point. In this context, a fastening point in particular is to be understood as a region in which two components are in essence immovably or fixedly connected to each other. The connection may be implemented in different manners such as in the form of an integral connection or by force locking or form locking. In particular, the carrier element and the circuit board are connected to each other by force locking and/or form locking or are integrally connected to each other, preferably at both fastening points. Preferably, the carrier element and the circuit board are electrically and mechanically connected in the region of the first fastening point, but are connected only mechanically and not electrically in the region of the second fastening point.

In particular, in accordance with an example embodiment embodiment of the present invention, the battery pack is part of a system which is made up of the battery pack and a consumer, and the consumer is supplied with energy via the battery pack during the operation. More specifically, the battery pack is implemented as a handheld machine battery pack. The battery pack is particularly realized as a exchangeable battery pack. In particular, the battery pack is able to be connected to a charging device for charging the battery pack. The battery pack has a housing in which at least one battery cell is accommodated. The housing of the battery pack is developed as an external housing, in particular. The battery pack, especially the housing of the battery pack, is connectable in a releasable manner via a mechanical interface to the consumer and/or to a charging device. The housing of the battery pack may have one or more housing part(s). The housing preferably includes a cell housing, which is developed to accommodate at least one battery cell, and especially all battery cells, of the battery pack. In particular, the cell housing is one of these housing parts. The housing parts are connected to one another by force locking, form locking and/or by an intermaterial connection.

In particular, the consumer may be developed as a gardening device such as a lawnmower or hedge clippers, as a household device such as an electrical window cleaner or handheld vacuum cleaner, as a handheld machine tool such as an angle grinder, a screwdriver, a drill, a hammer drill, etc., or as a measuring tool, e.g., a laser distance measuring device. In addition, it is also possible that the consumer is developed as some other device, in particular a portable device, such as a construction site light, a suction device or a construction site radio. The battery pack is able to be connected to the consumer via the mechanical interface, using a force locking or form locking connection. In an advantageous manner, the mechanical interface includes at least one control element via which the connection of the battery pack to the consumer and/or to the charging device is releasable. For instance, the control element may be developed as a button, lever or as a push button switch. In addition, the battery pack has at least one electrical interface via which the battery pack is able to be electrically connected to the consumer and/or the charging device. For instance, the battery pack can be charged and/or discharged via the electrical connection. Alternatively or additionally, it is also possible that information is transmittable via the electrical interface. The electrical interface is preferably developed as a contact interface in which the electrical connection is accomplished via physical contact between at least two conductive components. The electrical interface preferably includes at least two electrical contact elements. In particular, one of the electrical contact elements is developed as a positive contact and the other electrical contact element as a negative contact. Moreover, the electrical interface may have at least one additional contact, which is developed to transmit additional information to the consumer and/or to the charging device. Alternatively or additionally, the electrical interface may have a secondary charge coil element for inductive charging. Moreover, the at least one battery cell, which is electrically connectable to the consumer via the electrical contact device, is disposed in the housing of the battery pack. The battery cell is able to be developed as a galvanic cell in which one cell pole comes to lie at one end and a further cell pole at an opposite end. In particular, the battery cell has a positive cell pole at one end and a negative cell pole at an opposite end. The battery cells are preferably developed as NiCd or NiMh cells, more preferably as lithium-based battery cells or Li-ion battery cells. Generally, the battery voltage of the battery pack is a multiple of the voltage of a single battery cell and results from the interconnection (parallel or serial) of the battery cells. In conventional battery cells having a voltage of 3.6V, this therefore results in an exemplary battery voltage of 3.6V, 7.2V, 10.8V, 14.4V, 18V, 36V, 54V, 108V, etc.

Preferably, the battery cell is developed as an at least essentially cylindrical round cell, and the cell poles are situated at ends of the cylinder shape.

The electronics unit may include a memory unit in which information is stored. Additionally or alternatively, it is also possible that the information is ascertained by the electronics unit. The information may involve a charge state of the battery pack, a temperature inside the battery pack, an encoding or a residual capacitance of the battery pack, for example. It is also possible that the electronics unit is developed to regulate or control the charge and/or discharge process of the battery pack. For example, the electronics unit may include a processing unit, a control unit, a transistor, a capacitor, and/or the memory unit. In addition, the electronics may have a sensor element or a plurality of sensor elements such as the temperature sensor for ascertaining the temperature inside the battery pack or a motion sensor for ascertaining movements. The electronics unit may alternatively or additionally have an encoding element such as an encoding resistor.

In this context, a circuit board particularly is to be understood as a carrier of electronic components. The circuit board is developed from an electrically insulating material. The circuit board is preferably made from a fiber-reinforced plastic material. Preferably, the circuit board extends essentially completely within a plane. The circuit board may be developed with one side or two sides. In a one-sided development of the circuit board, all electronic components are situated on the same side of the circuit board. In particular, the circuit board at least partially includes the electrical interface.

The circuit board preferably has at least two electrical contact elements, which are provided as power contacts for the energy supply.

The temperature sensor is developed to detect a temperature, in particular a temperature inside the battery back, preferably a temperature of a battery cell. The battery pack may have a single or multiple temperature sensor(s). The temperature sensor is able to be developed as a thermistor, e.g., as a negative temperature coefficient thermistor, in particular an NTC, or as a positive temperature coefficient thermistor, in particular a PTC. The temperature sensor is able to be placed on a side of the carrier element that faces the circuit board or faces away from it.

The positioning element is specifically developed for positioning the temperature sensor and/or the carrier element at the height perpendicular to an extension plane of the circuit board.

Alternatively or additionally, it would also be possible to develop the positioning element for positioning the temperature sensor and/or the carrier element in the extension plane of the circuit board.

It is furthermore provided that the positioning element has a thickness, especially in the unassembled state, that is at least half as great and preferably at least as great as a thickness of the circuit board. The positioning element preferably has a thickness that corresponds at least to a height of the temperature sensor, preferably to two or three times the height of the temperature sensor. This particularly makes it possible to realize an especially advantageous positioning. The temperature sensor device particularly is provided as an installation module, which is installed as one piece during the assembly of the battery pack. In the unassembled state, the temperature sensor is not yet resting against the component to be measured, in particular against a battery cell. More specifically, the positioning element is compressed in its height during the assembly so that it has at least regionally a smaller thickness in the assembled state than in the unassembled state.

It is furthermore provided that the positioning element is elastically deformable. In an advantageous manner, this allows the positioning element to be protected, e.g., from vibrations and shocks. As an alternative, a plastically deformable positioning element would be possible as well, but this would not provide the advantage of the damping effect of an elastically deformable positioning element. The positioning element in particular has a compression set of less than 50%, preferably of less than 25%, preferably of less than 10% and especially preferably of essentially 0%. In particular, the compression set is to be understood as a compression set specified according to DIN ISO 815. More specifically, the positioning element is developed in an elastically deformable manner such that, in the assembled state, the positioning element is at least regionally compressed by at least 5%, preferably by at least 15%, and preferably by at least 40%.

In addition, it is provided that the positioning element is developed to be electrically and/or thermally insulating. This advantageously makes it possible to prevent short circuits and/or to increase the measuring accuracy. In particular, the positioning element is placed in such a way that the temperature sensor and/or the carrier element in the region of the second fastening point is/are electrically insulated from the circuit board. The positioning element is preferably placed in such a way that the temperature sensor is essentially thermally insulated from the circuit board. The thermal decoupling of the temperature sensor from the circuit board advantageously achieves a considerably more accurate measurement of the temperature of the battery cell.

It is furthermore provided to connect the positioning element to the circuit board and/or to the carrier element in an integral fashion. In an advantageous manner, this makes it possible to realize a secure fastening of the temperature sensor in the region of the second fastening point. The integral connection is able to be implemented via an intermaterial connection such as via a double-sided adhesive tape.

It is possible that the positioning element is bonded to the circuit board and/or to the carrier element.

It is furthermore provided that the positioning element is developed from an elastomer, in particular a foam material. This advantageously makes it possible to provide an economical positioning element. Preferably, the foam material is produced completely from an open-pore foam material. For example, the foam material may be developed from neoprene. Alternatively, it is also possible that the foam material is partially or completely developed from a closed-pore foam material. The elastomer may also involve a TPE injection molded element. The injection molded element is able to be connected to the circuit board by a force-locked or form-locked connection and especially be prefixed. It is alternatively also possible that the positioning element is developed as a spring element or as a double-sided adhesive.

In addition, it is provided to develop the carrier element as a flexible circuit board or as a cable element, in particular a wired temperature sensor. In the context of this application, a flexible circuit board particularly is to be understood as a thin, flexible circuit board. The flexible circuit board has a pliable and/or foldable development, in particular. The flexible circuit board especially is developed from a foil, preferably a polyimide foil or a comparable material. The carrier element may include circuit traces or wiring elements, which electrically connect the temperature sensor to the circuit board and/or to the electronics unit of the battery pack. The circuit traces preferably have a cross-section of less than 0.100 mm², in particular less than 0.050 mm², and preferably less than 0.010 mm². The wire elements preferably have a cross-section that is greater than 0.100 mm².

In addition, the present invention relates to a battery pack which includes a temperature sensor device as described above. The temperature sensor and/or the carrier elements rest(s) against a battery cell and/or a cell holder in such a way that the positioning element applies a force to the temperature sensor in a direction opposite the circuit board, the positioning element in particular being compressed in the process.

In addition, in accordance with an example embodiment of the present invention, it is provided that the temperature sensor or the carrier element rests against the battery cell either directly or by way of a heat conduction element. This advantageously makes it possible to further improve the accuracy of the temperature measurement. The heat conduction element is preferably made from an elastomer. For example, the heat conduction element may be developed from a plastically deformable thermal paste. Alternatively, it is also possible that the heat conduction element is developed as a thermal pad or as a thermally conductive adhesive. The heat conduction element may also have an elastic development. In particular, the heat conduction element has an elastic development such that it partially or completely adapts itself to the surface to be measured in the assembled state. Alternatively, it is also possible that the heat conduction element has a rigid development such that it does not adapt itself to the surface to be measured in the assembled state and retains its shape. More specifically, the heat conduction element is developed in such a way that the carrier element is reinforced in the connected state. The heat conduction element is preferably developed as a stiffener or as a reinforcement element. The stiffener is developed from plastic or metal, in particular. The stiffener is preferably integrally connected to the carrier element. More specifically, the stiffener is developed to restrict the pliability of the carrier element in order to protect the carrier element. The heat conduction element is preferably developed from an electrically non-conductive material. For instance, the heat conduction element may be developed from polyimide, capton, FR4 or a similar material.

### BRIEF DESCRIPTION OF THE DRAWINGS

Additional advantages result from the following description of the figures. The figures and the description herein include numerous features in combination. One skilled in the art will expediently view the features also individually and combine them to meaningful further combinations, in view of the disclosure herein.

FIG. 1 shows a schematic side view of a handheld machine tool which includes a battery pack, in accordance with an example embodiment of the present invention.

FIG. 2 shows a schematic exploded view of the battery pack, in accordance with an example embodiment of the present invention.

FIG. 3 shows a side view of a temperature sensor device according to an example embodiment of the present invention;

FIG. 4 shows a perspective partial view of the temperature sensor device without a positioning element, in accordance with an example embodiment of the present invention.

FIG. 5 shows a cross-section of the battery pack in the region of the temperature sensor device, in accordance with an example embodiment of the present invention.

### DETAILED DESCRIPTION OF EXAMPLE EMBODIMENTS

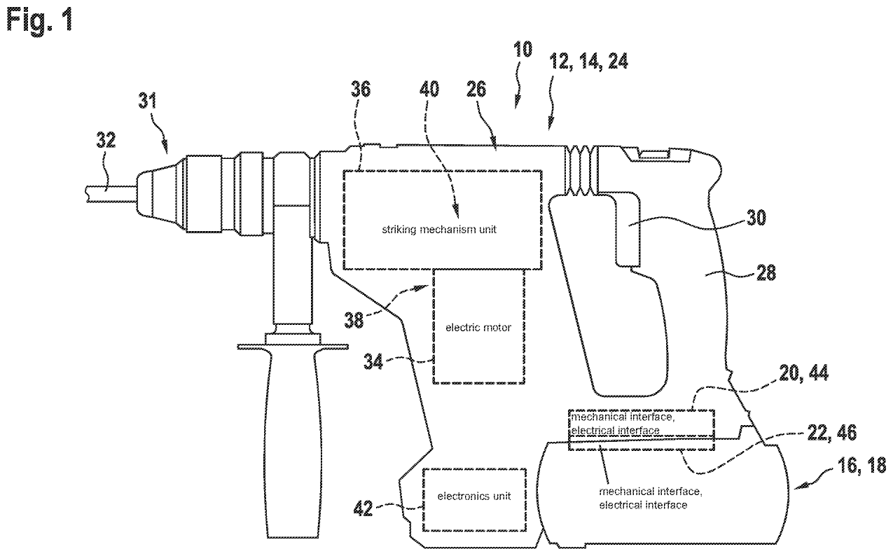

FIG. 1 shows a side view of a system 10, which is made up of a consumer 14 developed as a handheld machine tool 12, and a battery pack 18 developed as a handheld machine tool battery pack 16.

Handheld machine tool 12 thus is embodied as a battery-powered handheld machine tool and during its operation is supplied with energy via battery pack 18. Handheld machine tool 12 and battery pack 18 have a mechanical interface 20, 22 in each case, via which the two components of system 10 are reversibly connected to each other. Battery pack 18 thus is developed as an exchangeable battery pack and is able to be exchanged for an identical or a similar battery pack. Handheld machine 12 is developed as a hammer drill 24 by way of example.

Handheld machine tool 12 has a housing 26 on whose rear-side end a handle 28 is situated, which has a control switch 30 for switching handheld machine 12 on and off. Situated at the front end of housing 26 of handheld machine tool 12 is a tool receptacle 31, which is provided to accommodate an insertable tool 32. A drive unit 38, which has an electric motor 34 and a gear unit 36, is situated between handle 28 and tool receptacle 31. Gear unit 36 includes a striking mechanism unit 40 and is situated above electric motor 34. Striking mechanism unit 40 encompasses a pneumatic striking mechanism. Situated below electric motor 34 is an electronics unit 42, via which handheld machine tool 12 is able to be regulated or controlled. Battery pack 18 is situated underneath handle 28 and adjacent to electronics unit 42.

Battery pack 18 and consumer 14 have a mutually corresponding electrical interface 44, 46 in each case via which battery pack 18 is electrically connectable to consumer 14, in particular to electronics unit 42 of consumer 14. In the mutually connected state, battery pack 18 provides the energy supply for consumer 14.

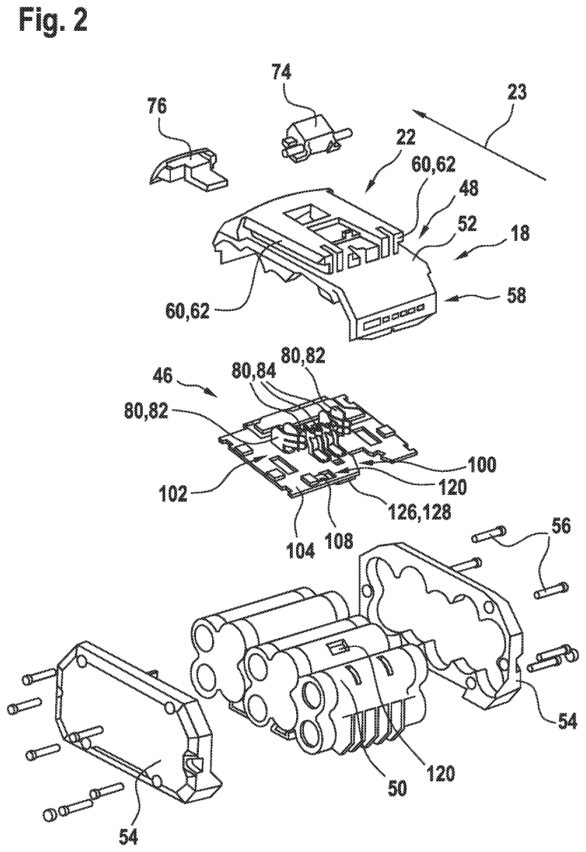

FIG. 2 shows a schematic exploded view of the battery pack according to an example embodiment of the present invention. In particular the size of circuit board 104 has been adapted for better clarity in this schematic view.

Via mechanical interface 22, battery pack 18 is mechanically connected to consumer 14 in a releasable manner. Battery pack 18 includes a housing 48, which is made up of multiple parts by way of example. Housing 48 is made from a plastic-containing housing material. Preferably, housing 48 is produced from a polycarbonate or a high-density polyethylene (HD PE). Housing 48 is developed as an outer housing, in particular. Housing 48 has a cell housing 50, an interface housing part 52 and two side housing parts 54. Housing parts 50, 52, 54 are connected to one another via fastening elements 56, which are embodied as screws by way of example. All housing parts 50, 52, 54 are at least partially developed as outer housing parts.

A state-of-charge display 58 via which the charge state of battery pack 18 is displayable is situated on the front side of battery pack 18. Housing 48 of battery pack 18, in particular interface housing part 52, includes mechanical interface 22. Battery pack 18 is exemplarily embodied as a sliding battery pack. Battery pack 18 is slipped onto handheld machine tool 12 along a connection direction 23 for the connection to handheld machine tool 12.

Mechanical interface 22 has a number of holding elements 60 on which battery pack 18 is retained when it is connected to handheld machine tool 12. Holding elements 60 are developed as guide rails 62 by way of example. Holding elements 60 extend essentially in parallel with connection direction 23 of battery pack 18. When connected to handheld machine tool 12, guide rails (not shown) of mechanical interface 20 of handheld machine tool 12 rest against guide rails 62. In addition, mechanical interface 22 of battery pack 18 has a locking element 74. Locking element 74 is movably supported in housing 48 of battery pack 18, in particular so that it is able to rotate. Locking element 74 is developed to lock battery pack 18 to handheld machine tool 12 in the connected state. Locking element 74 is developed as a latching element by way of example, which snaps into place in a recess (not shown) in housing 26 of handheld machine tool 12. To release this force-locked or form-locked connection, battery pack 18 is equipped with a control element 76, which is mechanically linked to locking element 74 and via which locking element 74 is able to be moved out of the recess in the connected state. Control element 76 is developed as a push button element by way of example and is operable in parallel with connection direction 23.

Battery cells 90 are accommodated in cell housing 50. Battery pack 18 exemplarily includes ten battery cells 90, which are situated in cell housing 50. Battery pack 18 is developed as an 18V battery pack. For example, battery pack 18 is developed as a two-layer battery pack 18. A two-layer battery pack 18 particularly means that battery cells 90 are situated in two layers, and that battery cells 90 within a layer are situated next to one another in a plane and the number of battery cells 90 within a layer it not lower than the number of layers. For example, a layer includes five battery cells 90. It is also possible to develop battery pack 18 as a three-layer or four-layer battery pack.

Electric interface 46 has five electrical contact elements 80 by way of example. In the assembled state, the five electrical contact elements 80 are situated between holding elements 60. Electrical contact elements 80 are at least partially developed for a connection to electrical contact elements (not shown) of electrical interface 44 of handheld machine tool 12 or to a charging device (not shown). Interface housing 52 has recesses in which electrical contact elements 80 are situated and by way of which they are accessible for the electrical connection. Two of electrical contact elements 80 are developed as power contacts 82 via which an electric current for an electric energy supply to handheld machine tool 12 is flowing during the operation. Three of the electrical contact elements 80 are developed as supplementary contacts 84. One of supplementary contacts 84 is developed as a temperature contact for transmitting a characteristic temperature variable. The other two supplementary contacts 84 are developed as encoding contacts and connected to an encoding resistor. One of the encoding contacts is provided for consumer 14, and the other encoding contact is provided for a charging device. In addition, further information is also exchangeable via the encoding contacts.

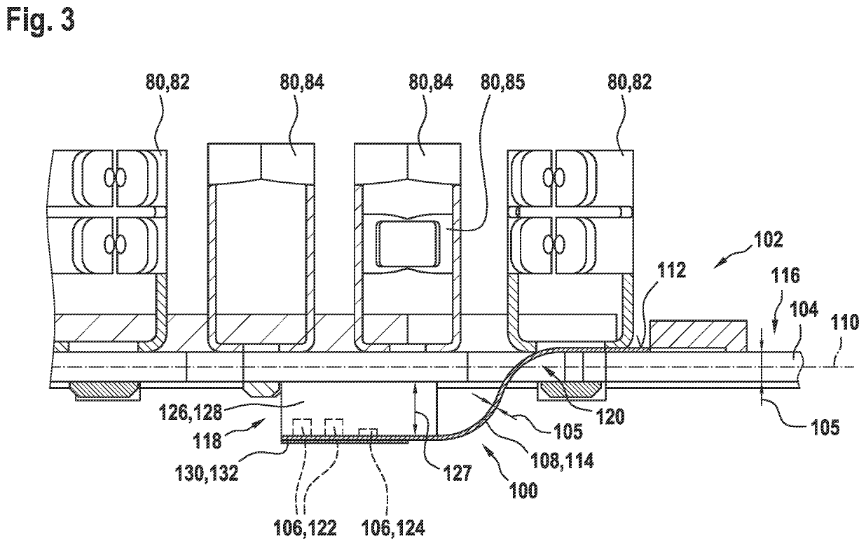

In addition, battery pack 18 includes a temperature sensor device 100. Temperature sensor device 100 has an electronics unit 102 including a circuit board 104, and at least one temperature sensor 106, which is connected to electronics unit 102 (see FIG. 3).

With the aid of a carrier element 108, temperature sensor 106 is connected to electronics unit 102. Electronics unit 102 includes further electronic components for the control or regulation of battery pack 18, such as a memory unit and a logic unit, which are not explicitly illustrated.

FIG. 3 shows temperature sensor device 100 in a side view in an unassembled state. Circuit board 104 is developed as a planar circuit board 104 and in essence extends completely within an extension plane 110. Circuit board 104 has a rigid development, in particular. Contact elements 80 are situated or fixed in place on a topside 112 of circuit board 104. Carrier element 108 is realized as a flexible circuit board 114 by way of example. Carrier element 108 has an elastic development. Carrier element 108 has a thickness 109, which is less than one half of thickness 105 of circuit board 104. Carrier element 108 is connected to circuit board 104 via a first fastening point 116 and a second fastening point 118. First fastening point 116 is situated at a distance from second fastening point 118. By way of example, first fastening point 116 and second fastening point 118 are situated on different sides of circuit board 104. For this purpose, circuit board 104 has a recess 120 through which carrier element 108 protrudes. In the process, carrier element 108 is bent, e.g., by approximately 45%, in a first direction and subsequently is bent, e.g., by approximately 45%, in a second direction situated opposite the first direction. First fastening point 116 in particular is disposed on topside 112 and second fastening point 118 is disposed on a side situated opposite to topside 112. The fastening of carrier element 108 in the region of first fastening point 116 is achieved by a solder connection by way of example. The solder connection is additionally protected, e.g., by an encapsulation. Via the solder connection, carrier element 108 is mechanically and electrically connected to circuit board 104. As an alternative, it is also possible that the fastening is implemented via a plug-in connection, which electrically and mechanically connects carrier element 108 to circuit board 104.

Temperature sensor device 100 has three temperature sensors 106 by way of example. Two of temperature sensors 106 are developed as NTCs 122, and one temperature sensor 106 is developed as a PTC 124. Temperature sensors 106 are placed on the same side of carrier element 108. By way of example, temperature sensors 106 are situated on a side of carrier element 108 that faces circuit board 104. Temperature sensors 106 are situated in the region of second fastening point 118.

Temperature sensor device 100 has a positioning element 126 for positioning temperature sensor 106. Positioning element 126 is developed as a foam material 128 by way of example. Positioning element 126 is situated between carrier element 108, in particular temperature sensors 106, and circuit board 104. By way of example, positioning element 126 has a thickness 127 that is greater than a thickness 105 of circuit board 104. Positioning element 126 has an elastic development such that it is regionally compressible when a force is applied.

In addition, temperature sensor device 100 has an optional heat conduction element 130, which is disposed on a side of carrier element 108 facing away from circuit board 104. Heat conduction element 130 is developed as a heat conduction pad 132 by way of example and is provided for a more optimal thermal coupling of temperature sensors 106 with the battery cells. In the region of second fastening point 118, carrier element 108 is integrally connected to positioning element 126, and positioning element 126 is integrally connected to circuit board 104. This is achieved with the aid of an adhesive agent by way of example, but other connection types are also possible. Carrier element 108 thus is connected to circuit board 104 only mechanically and not electrically in the region of second fastening point 118. Positioning element 126 has an electrically insulating development in order to electrically insulate carrier element 108 and temperature sensors 106 from circuit board 104. In addition, positioning element 126 has a thermally insulating development for thermally insulating temperature sensors 106 from circuit board 104 so that a more accurate measurement of the temperature of the battery cells is possible.

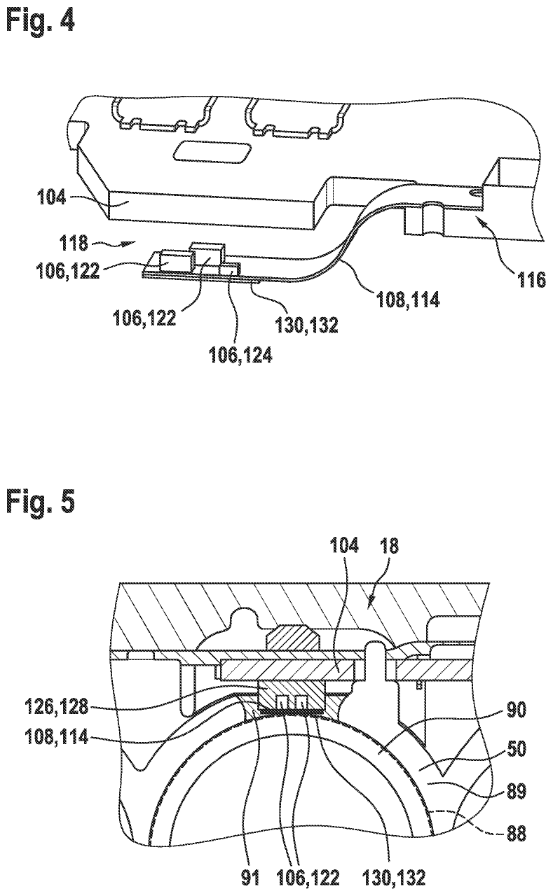

FIG. 4 shows a perspective partial view of temperature sensor device 100 according to the present invention without positioning element 126. In an alternative embodiment, it would also be possible to develop the temperature sensor device without a positioning element in the region of the temperature sensors, and instead to place second fastening point 118 also at a distance from temperature sensors 106 and to fasten it directly to the circuit board, similar to the already described first fastening point, for instance. In this embodiment as well, carrier element 108 advantageously has an elastic development so that temperature sensors 106 are freely arranged, but are situated in a tensioned region of carrier element 108. During the assembly, temperature sensors 106 are thereby pressed onto the surface to be measured counter to an intrinsic spring force of carrier element 108.

FIG. 5 shows a cross-section of temperature sensor device 100 installed in battery pack 18. Cell housing 50 of battery pack 18 has mounting regions 88 in which a single battery cell 90 is situated in each case. Alternatively, it would also be possible to develop cell housing 50 in such a way that multiple battery cells 90 are accommodated in a receiving region. Battery cells 90 are developed as cylindrical round cells. Receiving regions 88 are restricted by a wall 89 in each case, which is adapted to the shape of battery cells 90. Walls 89 at least regionally have a hollow-cylindrical form. By way of example, battery cells 90 in cell housing 50 in essence are completely surrounded by cell housing 50 along their cylindrical lateral surface. Preferably, the lateral surface of battery cells 90 essentially rests fully against wall 89 of receiving regions 88.

Cell housing 50, in particular wall 89 of cell housing 50, includes a recess 91 which is situated on a side of cell housing 50 facing circuit board 104. Recess 91 is preferably situated in a centered fashion with respect to battery cell 90 in order to allow for the most precise temperature measurement possible. Recess 91 is situated at a distance from recess 120 of circuit board 104 so that they are not situated on top of each other and carrier element 108 is able to be clamped between battery cell 90 and circuit board 104.

Carrier element 108, heat conduction element 130 and temperature sensors 106 are essentially situated completely within recess 91 of cell housing 50. Positioning element 126 is partially situated within recess 91 and partially outside recess 91 and thus is situated outside cell housing 50. Circuit board 104 rests against cell housing 50 and is braced thereon.

The distance between circuit board 104 and carrier element 108 or heat conduction element 130 is greater in the unassembled state than the distance between battery cell 90 and circuit board 104 in the assembled state. As a result, positioning element 126 made of foam material 128 yields during the assembly and is compressed so that a force is applied to carrier element 108 with temperature sensors 106 in the direction of battery cell 90. Positioning element 126 has an elastic development such that it is further compressible also in the assembled state. In an advantageous manner, positioning element 126 is able to partially or completely absorb vibrations and shocks so that temperature sensors 106 are protected and do not change their position.

In the illustrated embodiment, heat conduction element 130 has a rigid development such that it does not change its shape during the assembly. As a result, heat conduction element 130 rests only partially against the lateral surface of battery cell 90. In an advantageous manner, such a robust heat conduction element 130 protects temperature sensor device 100 from mechanical damage during the assembly. Alternatively, it would also be possible to use a flexible heat conduction element or to omit it so that the head conduction element or the carrier element adapts itself to the shape of the battery cell and thereby improves the thermal conduction. Positioning element 126 has an elastic development by way of example such that it essentially has no compression set. This means that it essentially assumes its original shape during the disassembly.

What is claimed is:

1. A temperature sensor device for a battery pack, comprising:
an electronics unit including a circuit board;
at least one temperature sensor which is connected to the electronics unit, the temperature sensor being connected to the electronics unit using a carrier element, the carrier element being fastened on the circuit board at a first fastening point and at a second fastening point on the circuit board, the at least one temperature sensor being situated in a region of the second fastening point; and
a positioning element, which is configured to position the at least one temperature sensor, is situated between the circuit board and the carrier element in the region of the second fastening point.

2. The temperature sensor device as recited in claim 1, wherein the carrier element and the circuit board: (i) are connected to each other by force locking and/or form locking, or (ii) integrally connected and immovably connected.

3. The temperature sensor device as recited in claim 1, wherein the positioning element has a thickness, in an unassembled state, that is at least half as great as a thickness of the circuit board.

4. The temperature sensor device as recited in claim 1, wherein the positioning element has a thickness, in an unassembled state, that is at least as great as a thickness of the circuit board.

5. The temperature sensor device as recited in claim 1, wherein the positioning element is elastically deformable.

6. The temperature sensor device as recited in claim 1, wherein the positioning element electrically insulating and/or thermally insulating.

7. The temperature sensor device as recited in claim 1, wherein the positioning element is integrally connected to the circuit board and/or to the carrier element.

8. The temperature sensor device as recited in claim 1, wherein the positioning element is made of an elastomer.

9. The temperature sensor device as recited in claim 8, wherein the positioning element is made of a foam material.

10. The temperature sensor device as recited in claim 1, wherein the positioning element is a spring element or a double-sided adhesive.

11. The temperature sensor device as recited in claim 1, wherein the carrier element is a flexible circuit board or a cable element or a wired temperature sensor.

12. The temperature sensor device as recited in claim 1, wherein at least one temperature sensor includes at least two temperature sensors, at least one temperature sensors is an NTC and one of the temperature sensors is a PTC.

13. The temperature sensor device as recited in claim 1, wherein the at least one temperature sensor includes at least two temperature sensors which are an NTC or a PTC.

14. A battery pack having a temperature sensor device, the temperature sensor device comprising:
an electronics unit including a circuit board;
at least one temperature sensor which is connected to the electronics unit, the temperature sensor being connected to the electronics unit using a carrier element, the carrier element being fastened on the circuit board at a first fastening point and at a second fastening point on the circuit board, the at least one temperature sensor being situated in a region of the second fastening point; and
a positioning element, which is configured to position the at least one temperature sensor, is situated between the circuit board and the carrier element in the region of the second fastening point.

15. The battery pack as recited in claim 14, wherein the temperature sensor and/or the carrier element rests against a battery cell and/or a cell holder such that the positioning element applies a force to the temperature sensor in a direction opposite the circuit board.

16. The battery pack as recited in claim 14, wherein the temperature sensor or the carrier element rests against the battery cell either directly or by way of a heat conduction element.
